(19) United States
(12) Patent Application Publication
(10) Pub. No.: US 2023/0396365 A1
(43) Pub. Date: Dec. 7, 2023

(54) NON-TRIGGER-BASED NEXT GENERATION VEHICLE-TO-EVERYTHING (NGV) RANGING

(71) Applicant: Intel Corporation, Santa Clara, CA (US)

(72) Inventors: Qinghua Li, San Ramon, CA (US); Bahareh Sadeghi, Portland, OR (US); Jonathan Segev, Sunnyvale, CA (US); Xiaogang Chen, Portland, OR (US); Thomas J. Kenney, Portland, OR (US); Robert J. Stacey, Portland, OR (US)

(21) Appl. No.: 18/031,468

(22) PCT Filed: Dec. 6, 2021
(86) PCT No.: PCT/US2021/061952

§ 371 Date: Apr. 12, 2023

Related U.S. Application Data
(60) Provisional application No. 63/136,173, filed on Jan. 11, 2021.

(51) Int. Cl. H04L 1/08; H04L 27/26; G01S 13/76

(52) U.S. Cl. CPC H04L 1/08; H04L 27/2607; G01S 13/767

(57) ABSTRACT

A next generation vehicle-to-everything (NGV) station (STA) operating as an initiating station (ISTA) for performing non-trigger-based NGV ranging may encode an NGV ranging null-data packet (NDP) announcement (NGV NDPA) frame for transmission to a responding station (RSTA) to initiate the non-trigger-based NGV ranging. The NGV STA may also encode an initiator-to-responder (I2R) NGV ranging null-data packet (NDP) (I2R NGV ranging NDP) for transmission following the NGV NDPA frame. The I2R NGV ranging NDP may be encoded in accordance with a NGV Ranging NDP format that may include an NGV signal field (NGV-SIG), a repeated NGV-SIG (RNGV-SIG), an NGV Short Training field (NGV-STF) and an NGV long training field (NGV-LTF). The NGV-LTF may include one or two sets of LTF symbols depending on a number of LTF symbol repetitions (LTF_REP). Each set of LTF symbols may have one or two LTF symbols depending on a number of spatial streams (NUM_SS) and the NGV-LTF may be encoded without a packet extension (PE).

### PRIORITY CLAIM

This application claims the benefit of priority to U.S. Provisional Patent Application Ser. No. 63/136,173, filed Jan. 11, 2021 [reference number AD4628-Z] which is incorporated herein by reference in its entirety.

### TECHNICAL FIELD

Embodiments pertain to wireless communications including wireless local area networks (WLANS). Some embodiments relate to ranging for next generation vehicle-to-everything (NGV) communication. Some embodiments relate to ranging in accordance with an IEEE 802.11bd standard or draft standard.

### BACKGROUND

One issue with next generation vehicle-to-everything (NGV) communication is that ranging, the ranging process and the associated control signalling for operating in accordance with IEEE 802.11bd are currently undefined. Thus there are needs for procedures for ranging for NGV communication.

### BRIEF DESCRIPTION OF THE DRAWINGS

FIG. 1 is a block diagram of a radio architecture in accordance with some embodiments.

FIG. 2 illustrates a front-end module circuitry for use in the radio architecture of FIG. 1 in accordance with some embodiments.

FIG. 3 illustrates a radio IC circuitry for use in the radio architecture of FIG. 1 in accordance with some embodiments.

FIG. 4 illustrates a baseband processing circuitry for use in the radio architecture of FIG. 1 in accordance with some embodiments.

FIG. 5 illustrates a WLAN in accordance with some embodiments.

FIG. 6 illustrates a frame exchange sequence for single user (SU) NGV ranging, in accordance with some embodiments.

FIG. 7 illustrates NGV-LTF symbol formats, in accordance with some embodiments.

FIG. 8 illustrates frame formats for NGV null data packet (NDP) in accordance with some embodiments.

FIG. 9 illustrates an NGV-LTF-2x symbol format, in accordance with some embodiments.

FIG. 10 illustrates a station information field in accordance with some embodiments.

FIG. 11 is a flow chart illustrating a procedure performed by an initiating station (ISTA) for performing non-trigger-based NGV ranging.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to a next generation vehicle-to-everything (NGV) station (STA). In these embodiments, when operating as an initiating station (ISTA) for performing non-trigger-based NGV ranging, the NGV STA may encode an NGV ranging null-data packet (NDP) announcement (NGV NDPA) frame for transmission to a responding station (RSTA) to initiate the non-trigger-based NGV ranging. The NGV STA may also encode an initiator-to-responder (I2R) NGV ranging null-data packet (NDP) (I2R NGV ranging NDP) for transmission following the NGV NDPA frame. In some embodiments, the I2R NGV ranging NDP may be encoded in accordance with a NGV Ranging NDP format. In these embodiments, the NGV ranging NDP may be encoded to include an NGV signal field (NGV-SIG), a repeated NGV-SIG (RNGV-SIG), an NGV Short Training field (NGV-STF) and an NGV long training field (NGV-LTF). In these embodiments, the NGV-LTF may include one or two sets of LTF symbols depending on a number of LTF symbol repetitions (LTF_REP). In these embodiments, each set of LTF symbols may have one or two LTF symbols depending on a number of spatial streams (NUM_SS). In these embodiments, the NGV-LTF may be encoded without a packet extension (PE).

In some embodiments, the non-trigger based NGV ranging may be performed in accordance with an IEEE 802.11bd standard or draft standard, although the scope of the embodiments is not limited in this respect.

In some embodiments, the NGV-LTF may be encoded in symbol format NGV-LTF-2x. In these embodiments, symbols of the NGV-LTF may have a duration of 8 microseconds (μs) with a cyclic prefix (CP) of 1.6 μs. In some embodiments, the NGV-SIG, the RNGV-SIG, the NGV-STF and the NGV-LTF, each may have a symbol duration of 8 μs.

In some embodiments, for two spatial streams (NUM_SS=2) with LTF symbol repetition (LTF_REP=1), a first LTF symbol for spatial streams 1 and 2 may be transmitted by a first antenna (antenna 1) and a second antenna (antenna 2) with the same phase, followed by a second LTF symbol for spatial streams 1 and 2 transmitted by the first antenna and the second antenna with opposite phases, respectively, followed by repetition of the first and the second LTF symbols by antenna 1 and antenna 2 as the third and fourth LTF symbols. In these embodiments, NGV-LTF-2x symbol format may comprise an NGV-LTF-2x symbol A1 and an NGV-LTF-2x symbol A2 for one spatial stream, and an NGV-LTF-2x symbol A1 and an NGV-LTF-2x symbol A2 followed by NGV-LTF-2x symbol B1 and an NGV-LTF-2x symbol B2 for two spatial streams.

An example of NGV-LTF with N_SS=2 and LTF_REP=1, the repetition may be done after the LTF symbols of all spatial streams are sent. For example, for two spatial streams with LTF symbol repetition, a first LTF symbol for the two spatial streams may be transmitted by multiple antennas with a set of phases, followed by a second LTF symbol for the two spatial streams transmitted by the same multiple antennas with a different set of phases, respectively, followed by repetition of the first and the second LTF symbols by the same multiple antennas as the third and fourth LTF symbols.

In some embodiments, the NGV STA may set a predetermined bit (i.e., B12) to a predetermine value (i.e., 1) in the NGV-SIG to indicate that that the NGV Ranging NDP is an NGV Ranging NDP with NGV-LTF repetition.

In some embodiments, for transmission of an NGV PPDU with a data field and for transmission of an NGV Ranging NDP without NGV-LTF repetition, the NGV STA may set the predetermined bit to another predetermined value (i.e., 0) of the NGV-SIG. In these embodiments, bit 12 (B12) of the NGV-SIG field may be used to indicate NGV-LTF repetition. In these embodiments, B12 may be set to 0 for an NGV PPDU with a Data field and an NGV ranging NDP without NGV-LTF repetition. In these embodiments, B12 may be set to I for an NGV Ranging NDP with NGV-LTF repetition. In these embodiments, the NGV Ranging NDP format may comprise a NGV PPDU without a data field.

In some embodiments, in response to transmission of the I2R NGV ranging NDP, the NGV STA may decode a responder-to-initiator NGV-NDP (R2I NGV NDP) received from the RSTA following by an R2I link management report (R2I LMR) frame. The R2I LMR frame may report an arrival time of the I2R NGV NDP and a departure time of the R2I NGV NDP.

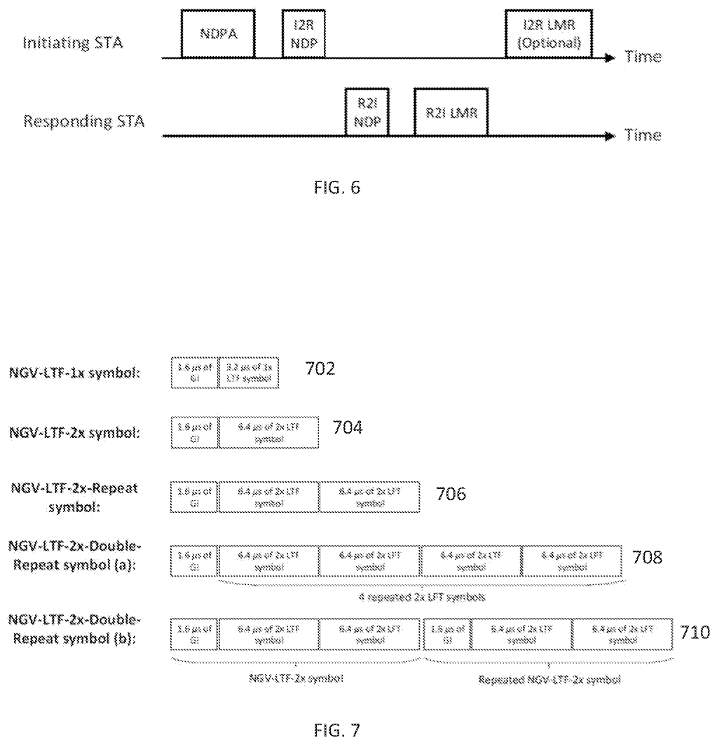

In some embodiments, the NGV STA may be configured for multiple frame transmission in an enhanced distributed coordination function (EDCA) TXOP. In these embodiments, during the EDCA TXOP for single user (SU) NGV ranging, the NGV STA may transmit the NGV Ranging NDP Announcement frame, may transmit the I2R NGV ranging NDP an SIFS after the NGV Ranging NDP Announcement frame, may receive the R2I NGV ranging NDP an SIFS after the I2R NGV ranging NDP, may receive the R2I LMR frame an SIFS after the R2I NGV ranging NDP, and may optionally transmit a I2R LMR frame an SIFS after receipt of the R2I LMR frame. An example of this is illustrated in FIG. 6 described in more detail below. In some embodiments, the ISTA may obtain the TXOP, although this is not a requirement.

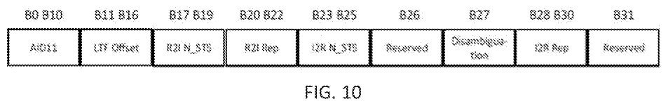

In some embodiments, the NGV STA may encode the NGV NDPA frame to include a STA information field (see FIG. 10). In these embodiments, for NGV ranging, the NGV STA may set one or more subfields of the STA information as follows: an LTF Offset subfield may be set to zero, an R2I N_STS subfield may be set to the number of spatial streams of the R2I NGV ranging NDP or the number of spatial streams of the R2I NGV ranging NDP minus 1, an R2I Rep subfield may be set to 0 if the NGV-LTF in the R2I NGV ranging NDP is not repeated and may be set to 1 if the NGV-LTF in the R2I NGV ranging NDP is repeated, an I2R N_STS subfield may be set to a number of spatial streams of the I2R NGV ranging NDP or a number of spatial streams of the I2R NGV ranging NDP minus 1, and an I2R Rep subfield may be set to 0 if the NGV-LTF in the R2I NGV ranging NDP is not repeated and may be set to 1 if the NGV-LTF in the R2I NGV ranging NDP is repeated.

In some of these embodiments, the N_STS subfield may be set according to the number of spatial streams and Rep subfield may be set according to the number of LTF repetitions, although the scope of the embodiments is not limited in this respect.

Some embodiments are directed to non-transitory computer-readable storage medium that stores instructions for execution by processing circuitry of a next generation vehicle-to-everything (NGV) station (STA). In these embodiments, when operating as an initiating station (ISTA) for performing non-trigger-based NGV ranging, the processing circuitry may encode an NGV ranging null-data packet (NDP) announcement (NGV NDPA) frame for transmission to a responding station (RSTA) to initiate the non-trigger-based NGV ranging. The processing circuitry may also encode an initiator-to-responder (I2R) NGV ranging null-data packet (NDP) (I2R NGV ranging NDP) for transmission following the NGV NDPA frame. The I2R NGV ranging NDP may encoded in accordance with a NGV Ranging NDP format as discussed herein.

Some embodiments are directed to next generation vehicle-to-everything (NGV) station (STA) that when operating as a responding station (RSTA) for performing non-trigger-based NGV ranging, the NGV STA may be configured to decode an NGV ranging null-data packet (NDP) announcement (NGV NDPA) frame received from an initiating station (ISTA). The NGV NDPA may initiate non-trigger-based NGV ranging. The NGV STA may also decode an initiator-to-responder (I2R) NGV ranging null-data packet (NDP) (I2R NGV ranging NDP) received from the ISTA following the NGV NDPA frame. The I2R NGV ranging NDP may be encoded in accordance with a NGV Ranging NDP format as discussed herein.

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM 104A and FEM 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM 104A or 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In some embodiments, the radio architecture 100 may be configured for Extremely High Throughput (EHT) communications in accordance with the IEEE 802.11be standard. In these embodiments, the radio architecture 100 may be configured to communicate in accordance with an OFDMA technique, although the scope of the embodiments is not limited in this respect. In some embodiments, the radio architecture 100 may be configured for next generation vehicle-to-everything (NGV) communications in accordance with the IEEE 802.11bd standard and one or more stations including the AP 502 may be next generation vehicle-to-everything (NGV) stations (STAs).

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio-architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies, however.

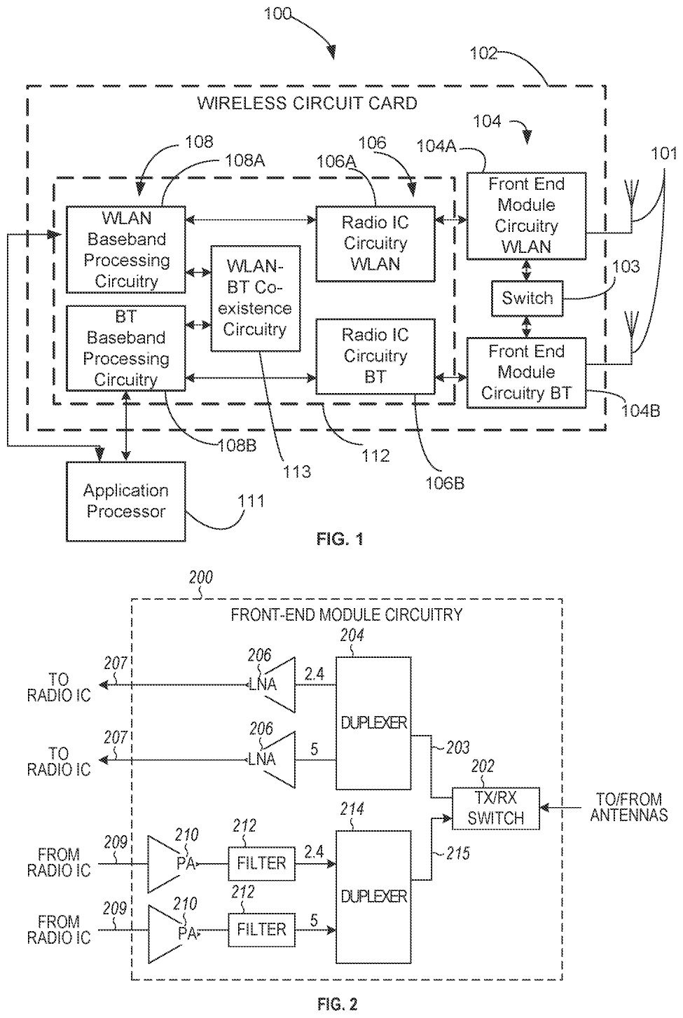

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

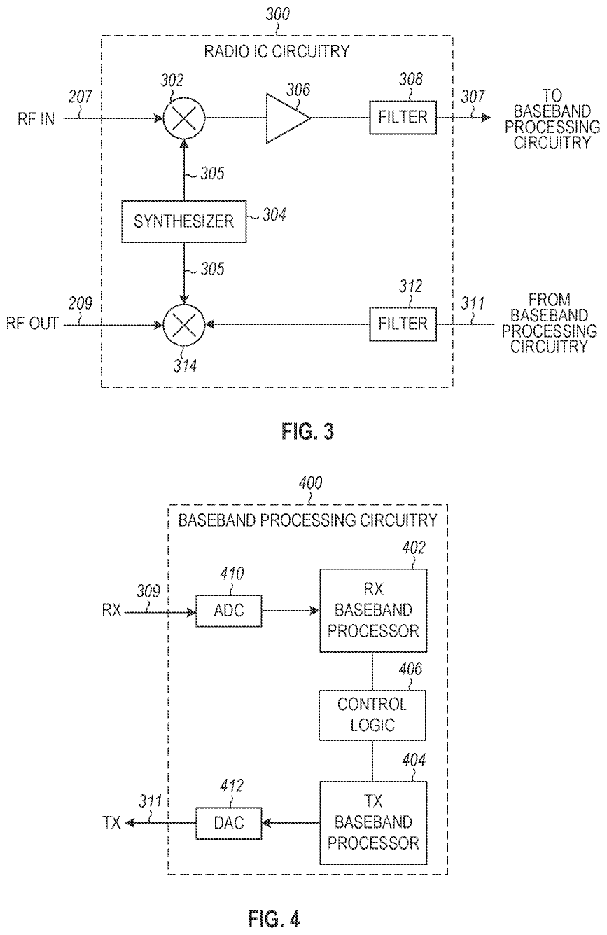

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

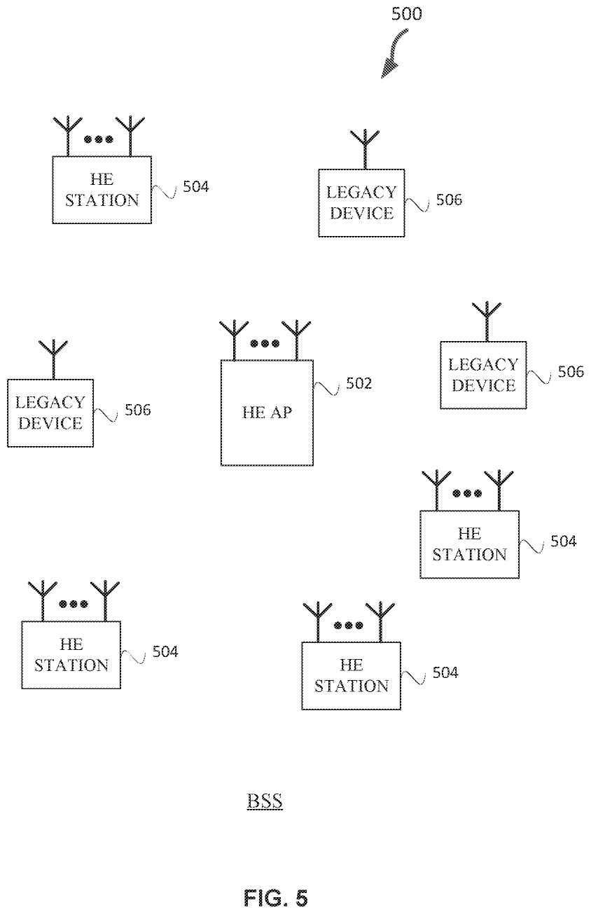

FIG. 5 illustrates a WLAN 500 in accordance with some embodiments. The WLAN 500 may comprise a basis service set (BSS) that may include a HE access point (AP) 502, which may be an AP, a plurality of high-efficiency wireless (e.g., IEEE 802.1 lax) (HE) stations 504, and a plurality of legacy (e.g., IEEE 802.11n/ac) devices 506. In some embodiments, WLAN 500 may be configured for Extremely High Throughput (EHT) communications in accordance with the IEEE 802.11be standard and one or more stations including the AP 502 may be EHT STAs. In some embodiments, WLAN 500 may be configured for next generation vehicle-to-everything (NGV) communications in accordance with the IEEE 802.11bd standard and one or more stations including the AP 502 may be next generation vehicle-to-everything (NGV) stations (STAs).

The HE AP 502 may be an AP using the IEEE 802.11 to transmit and receive. The HE AP 502 may be a base station. The HE AP 502 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one HE AP 502 that is part of an extended service set (ESS). A controller (not illustrated) may store information that is common to the more than one HE APs 502.

The legacy devices 506 may operate in accordance with one or more of IEEE 802.11 a/b/g/n/ac/ad/af/ah/aj/ay, or another legacy wireless communication standard. The legacy devices 506 may be STAs or IEEE STAs. The HE STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.1 lax or another wireless protocol. In some embodiments, the HE STAs 504 may be termed high efficiency (HE) stations.

The HE AP 502 may communicate with legacy devices 506 in accordance with legacy IEEE 802.11 communication techniques. In example embodiments, the HE AP 502 may also be configured to communicate with HE STAs 504 in accordance with legacy IEEE 802.11 communication techniques.

In some embodiments, a HE frame may be configurable to have the same bandwidth as a channel. The HE frame may be a physical Layer Convergence Procedure (PLCP) Protocol Data Unit (PPDU). In some embodiments, there may be different types of PPDUs that may have different fields and different physical layers and/or different media access control (MAC) layers.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE frame may be configured for transmitting a number of spatial streams, which may be in accordance with MU-MIMO and may be in accordance with OFDMA. In other embodiments, the HE AP 502, HE STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE communications. In accordance with some IEEE 802.11 embodiments, e.g., IEEE 802.11ax embodiments, a HE AP 502 may operate as a master station which may be arranged to contend for a wireless medium (e.g., during a contention period) to receive exclusive control of the medium for an HE control period. In some embodiments, the HE control period may be termed a transmission opportunity (TXOP). The HE AP 502 may transmit a HE master-sync transmission, which may be a trigger frame or HE control and schedule transmission, at the beginning of the HE control period. The HE AP 502 may transmit a time duration of the TXOP and sub-channel information. During the HE control period, HE STAs 504 may communicate with the HE AP 502 in accordance with a non-contention based multiple access technique such as OFDMA or MU-MIMO. This is unlike conventional WLAN communications in which devices communicate in accordance with a contention-based communication technique, rather than a multiple access technique. During the HE control period, the HE AP 502 may communicate with HE stations 504 using one or more HE frames. During the HE control period, the HE STAs 504 may operate on a sub-channel smaller than the operating range of the HE AP 502. During the HE control period, legacy stations refrain from communicating. The legacy stations may need to receive the communication from the HE AP 502 to defer from communicating.

In accordance with some embodiments, during the TXOP the HE STAs 504 may contend for the wireless medium with the legacy devices 506 being excluded from contending for the wireless medium during the master-sync transmission. In some embodiments the trigger frame may indicate an uplink (UL) UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The HE AP 502 may also communicate with legacy stations 506 and/or HE stations 504 in accordance with legacy IEEE 802.11 communication techniques. In some embodiments, the HE AP 502 may also be configurable to communicate with HE stations 504 outside the HE TXOP in accordance with legacy IEEE 802.11 communication techniques, although this is not a requirement.

In some embodiments the HE station 504 may be a “group owner” (GO) for peer-to-peer modes of operation. A wireless device may be a HE station 502 or a HE AP 502.

In some embodiments, the HE station 504 and/or HE AP 502 may be configured to operate in accordance with IEEE 802.11mc. In example embodiments, the radio architecture of FIG. 1 is configured to implement the HE station 504 and/or the HE AP 502. In example embodiments, the front-end module circuitry of FIG. 2 is configured to implement the HE station 504 and/or the HE AP 502. In example embodiments, the radio IC circuitry of FIG. 3 is configured to implement the HE station 504 and/or the HE AP 502. In example embodiments, the base-band processing circuitry of FIG. 4 is configured to implement the HE station 504 and/or the HE AP 502.

In example embodiments, the HE stations 504, HE AP 502, an apparatus of the HE stations 504, and/or an apparatus of the HE AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein.

In example embodiments, the HE station 504 and/or the HE AP 502 are configured to perform the methods and operations/functions described herein. In example embodiments, an apparatus of the HE station 504 and/or an apparatus of the HE AP 502 are configured to perform the methods and functions described herein. The term Wi-Fi may refer to one or more of the IEEE 802.11 communication standards. AP and STA may refer to HE access point 502 and/or HE station 504 as well as legacy devices 506.

In some embodiments, a HE AP STA may refer to a HE AP 502 and a HE STAs 504 that is operating a HE APs 502. In some embodiments, when an HE STA 504 is not operating as a HE AP, it may be referred to as a HE non-AP STA or HE non-AP. In some embodiments, HE STA 504 may be referred to as either a HE AP STA or a HE non-AP.

A new 802.11ngv air interface may be defined that is understood by legacy 80.211p (“11p) STAs (forward-compatible) but still provides improvements especially with regards to range: legacy compatible 802.11ngv (“11ngv) PPDU format (also referred to as next generation vehicle (NGV) Control PHY), and to define another 802.11ngv air interface that is not understood by legacy 11p STAs: legacy non-compatible 11ngv PPDU format (also referred to as NGV Enhanced PHY).

With the increased focus on enabling smart and increasingly autonomous vehicles, Vehicle-to-everything (V2X) has become one of the main target use cases to support over next-generation of wireless communication technologies, such as 5G. V2X communication is the passing of information from a vehicle to any entity that may affect the vehicle, and vice versa. It is a vehicular communication system that incorporates other more specific types of communication as V2I (Vehicle-to-Infrastructure), V2N (Vehicle-to-network), V2V (Vehicle-to-vehicle), V2P (Vehicle-to-Pedestrian), V2D (Vehicle-to-device) and V2G (Vehicle-to-grid).

Wireless ranging is a feature for 802.11bd, the next generation V2X (NGV) communications system. The ranging signal and control signaling are missing in the 802.11 specification draft. Existing solution was to use 802.11az bands to do the ranging for 802.11bd device.

Since the existing solution requires operations in another band, it is desirable to have a default solution that operates in the 802.11bd band.

Example embodiments of the present disclosure relate to systems, methods, and devices for NDP and NDPA Designs for 802.11bd.

In one embodiment, a ranging system may modify the NDP and NDPA frames of 11ax and 11az from designing the NDP and NDPA of 11bd. Although the physical layer of 11bd differs from 11ax, it is much simpler than those of 11ax and 11az. Therefore, simplifying the NDP and NDPA frames for 11ax and 11az for 11bd. The 11bd bands are reserved for vehicular communications. Having the ranging support in 11bd bands enhances the deployment of 11bd and is required by the 11bd task group.

No frame exchange sequence and no frame format are defined for 802.11bd ranging in the 802.11 spec draft. The frame exchange sequence for 802.11bd single user (SU) ranging can be the same as the 802.11az SU ranging as illustrated in FIG. 6. From the left to the right in FIG. 6, the initiating station (ISTA) sends a null data packet announcement (NDPA) frame to tell the responding station (RSTA) the beginning of the ranging, the format of the subsequent null data packet (NDP) frame(s), and the requirement/configuration information about the subsequent location measurement reports (LMRs). Following the NDPA, the ISTA sends the initiator-to-responder (I2R) NDP frame to sound the channel. After the I2R NDP, the responder sends the responder-to-initiator (R2I) NDP frame to sound the channel reversely. Following the R2I NDP, the responder sends R2I location measurement report (LMR) reporting the arrival time of the I2R NDP and the departure time of the R2I NDP so that the ISTA can calculate the roundtrip time for estimating the distance. Finally, an I2R LMR may be optionally sent by the ISTA reporting the departure time of I2R NDP and the arrival time of the R2I NDP so that the RSTA can also calculate the roundtrip time for estimating the distance. The spacing between the frames in FIG. 6 is short inter-frame space (SIFS). For 11bd, the SIFS may be 32 microseconds.

For simplicity, 11bd may only supports immediate feedback since the bandwidth is small, i.e., 10 or 20 MHz, and the SIFS is long, i.e., 32 microseconds. For immediate feedback, the LMR reports the measurement results of the NDP frames in the current measurement round (that is shown in FIG. 6) instead of the previous measurement round.

NGV-LTF SyMbol

FIG. 7 illustrates NGV-LTF symbol formats, in accordance with some embodiments. Example NGV-LTF symbol formats are illustrated in FIG. 7. Each of the NGV-LTF symbol formats 702, 704, 706, 708 and 710 comprise a single NGV-LTF symbol. The single NGV-LTF symbol may have one or more LTF symbols (i.e., OFDM symbols). For NGV-LTF repetition, the NGV-LTF symbol is repeated.

In these embodiments, the total number of LTF symbols in an NGV-LTF symbol may be one, two, or four. For example, NGV-LTF symbol formats 702 and 704 have one LTF symbol, NGV-LTF symbol format 706 has two LTF symbols, and NGV-LTF symbol formats 708 and 710 have four LTF symbols. NGV-LTF symbol format 708 has four repeated LTF symbols proceeded by a GI. NGV-LTF symbol format 710 is a doubled version NGV-LTF symbol format 706.

For transmission of one spatial stream without NGV-LTF symbol repetition, the number of NGV-LTF symbols in the NGV-LTF is one. For transmission of one spatial stream with NGV-LTF repetition, the number of NGV-LTF symbols in the NGV-LTF is two. For transmission of two spatial streams without NGV-LTF repetition, the number of NGV-LTF symbols in the NGV-LTF is two. For transmission of two spatial streams with NGV-LTF repetition, the number of NGV-LTF symbols in the NGV-LTF is four.

For example, if NGV-LTF symbol format 704 is used for transmission of one spatial stream with NGV-LTF repetition, the number of NGV-LTF symbols in the NGV-LTF is two. Therefore the NGV Long Training Field (NGV LTF) would comprise two repetitions of NGV-LTF symbol format 704 which comprises two NGV-LTF symbols.

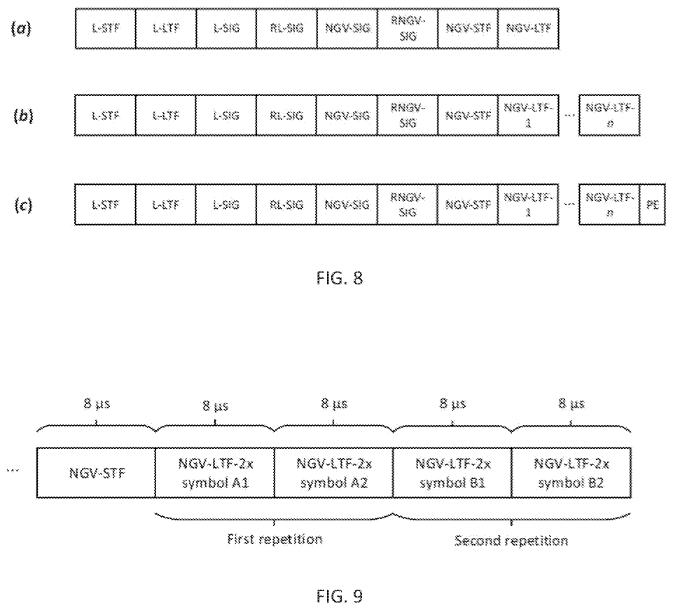

The existing NGV-LTF symbol (not field) structures are shown on the first 3 row of FIG. 7. For increasing the sounding signal energy, repetition may be used. There are two ways to do the repetition. The first option is to do the repetition at NGV-LTF symbol level as illustrated in FIG. 7 rows 2-5. The other option is to do repetition at NGV-LTF field level, i.e., NGV-LTF level repetition as illustrated in FIGS. 8 (b) and (c). It should be noticed that NGV-LTF field consists of NG-LTF symbols, which can be P-matrix encoded for the transmission of multiple spatial streams. The last two rows of FIG. 7 show two options to increase the sounding energy of NGV-LTF-2x symbol by 4 times. The NGV-LTF-2x-Double-Repeat (a) on row 4 of FIG. 7 consists of four 2x LTF symbols and one guard interval (GI). It is new and requires hardware addition. The NGV-LTF-2x-Double-Repeat (b) on row 5 of FIG. 7 consists of four 2x LTF symbols and two GIs. It is a simple repetition of NGV-LTF-2x-Repeat symbol on row 3. It is easier to implement at the cost of one additional GI than NGV-LTF-2x-Double-Repeat symbol (a). Another example of an NGV-LTF-2x symbol format is illustrated in FIG. 9.

FIG. 9 illustrates a portion of a NGV frame, in accordance with some embodiments. The NGV frame portion illustrated in FIG. 9 may be a portion of an NGV NDPA or NGV NDPA (e.g., see FIG. 8 or FIG. 10) and includes a NGV STF followed by a NGV LTF. The NGV LTF shown in FIG. 9 comprises two repetitions of the NGV-LTF symbol. Each NGV-LTF symbol may be in accordance with NGV-LTF symbol format 704 (FIG. 7).

For example, if NGV-LTF symbol format 704 is used for transmission of one spatial stream with NGV-LTF repetition, the number of NGV-LTF symbols in the NGV-LTF is two. Therefore the NGV Long Training Field (NGV LTF) would comprise two repetitions of NGV-LTF symbol format 704 which comprises two NGV-LTF symbols, as illustrated in FIG. 9.

NDP Frame

Reusing the components of existing 11bd data frame, the structure of 11bd NDP frame is illustrated in FIG. 8, where three options are shown. Option (a) is the simplest among the three. It is the same as data frame except the data symbols and midambles are removed. The channel sounding signal for ranging is at the next generation V2X long training field (NGV-LTF) portion in FIG. 8. There are three NGV-LTF symbol types defined in the 802.11 spec draft for data frame, NGV-LTF-1x, NGV-LTF-2x, and NGV-LTF-2x-Repeat is illustrated in first three rows of FIG. 7, whose sounding signal energies are sequentially doubled. One, or two, or all of the three may be reused for ranging NDP. For simplicity, only one or two of the three may be reused for ranging NDP. For example, only NGV-LTF-2x and/or NGV-LTF-2x-Repeat are used in ranging NDP. The reason is as follows. Since the sounding signal energy of 2x LTF is twice of 1x LTF and the sounding signal energy of NGV-LTF-2x-Repeat is twice of NGV-LTF-2x, the higher energy may ensure the ranging accuracy in long distance applications at small costs of transmission time consumption.

Option (b) in FIG. 8 is a simple extension of Option (a) adding the support of repetition. NGV-LTF field is repeated n times for boosting the signal energy. For example, for n=4, the NGV-LTF is repeated such that there are 4 copies of the same NGV-LTF field for boosting the sounding signal energy.

Option (c) in FIG. 8 adds another support to Option (a) and Option (b), which is the packet extension (PE). PE is appended to the NGV-LTF for providing the receiver additional processing time. Since it takes time for the receiver to estimate the 1^{st} arrival time of the sounding signal and the transmitter may ask receiver to provide the measurement report right after the bidirectional sounding, the transmitter can send a packet extension to provide the receiver additional processing time. The PE may be shorter than or equal to one OFDM symbol duration, e.g., 1.6, 2.0, 3.2, 4.0, 4.8, 6.0, 6.4, or 8.0 microseconds. The PE duration may be negotiated between the ISTA and RSTA and indicated in the NGV-SIG and RNGV-SIG of the NDP and may be the preceding NDPA. The PE carries signal that the receiver doesn't need to receive or process. For simplicity, the PE duration may be a fixed number, e.g., 8 microseconds.

For combating the multipath delay, guard interval (GI) is applied to each sounding symbol of the NGV-LTF as illustrated in FIG. 7. The GI duration can be the same as the one used by 11bd data symbol, i.e., 1.6 microseconds.

Although it is proposed to have an NDPA before the sounding NDPs, a third-party device may not receive the NDPA due to the hidden problem or cochannel interference. In this case, the third-party device may not be able to interpret the sounding NDP frame correctly. For clarification, it is desirable that the NDP frame can indicate itself so that intended and unintended receivers can identify the NDP and know its format explicitly. To indicate the NDP frame, the NGV-SIG may be used, though using L-SIG is also doable with more changes. The existing fields in NGV-SIG are listed in Table 1. It should be noticed that there are unused or reserved entries in some fields and reserved field (or reserved bits). These reserved entries or bits can be used to indicate:
1: NDP frame.
2: NGV-LTF type.
3: Repetition of NGV-LTF field.
4: Packet extension.

Some examples are listed as follows. In general, the NDP frame may be indicated in three ways:
1. Reserved entry in B8-B9 Midamble Periodicity, i.e., value 3.
2. Reserved entries in B3-B6 MCS, values 11-15.
3. Reserved bits in B12-B13.

Once the NDP frame is indicated, the other bits except B14-B23 can be redefined to indicate the NGV-LTF type and/or NGV-LTF field repetition and/or packet extension.

TABLE 1
The fields in NGV-SIG.

| | | Number | |
|---|---|---|---|
| Bit | Field | of Bits | Description |
| B1-B2 | PHY | 2 | Set to 0 for NGV PHY, other three |
| | Version | | options are reserved for future |
| | | | generations. |
| B3 | Bandwidth | 1 | Set to 0 for 10 MHz and set to 1 for 20 |
| | | | MHz. |
| B3-B6 | MCS | 4 | For 10 MHz PPDU, set to n for MCS |
| | | | n, where n = 0□□1□□2□□□□□8, |
| | | | and 10. Values 9 and 11-15 are |
| | | | reserved. |
| | | | For 20 MHz PPDU, set to n for MCS |
| | | | n, where n = 0□□1□□2□□□□□□□. |
| | | | Values 11-15 are reserved. |
| B7 | Nss | 1 | Set to 0 for one spatial stream and set |
| | | | to 1 for two spatial streams. |
| B8-B9 | Midamble | 2 | Set to 0 for 4 symbols; |
| | Periodicity | | Set to 1 for 8 symbols; |
| | | | Set to 2 for 16 symbols; |
| | | | Value 3 is reserved. |
| B10 | LTF | 1 | 0: NGV-LTF-2x; |
| | Format | | 1: NGV-LTF-1x. |
| B11 | LDPC | 1 | Set to 1 if the LPDC PPDU |
| | Extra | | encoding process results in an extra |
| | OFDM | | OFDM symbol as described in |
| | Symbol | | 21.3.10.5.4 (LDPC coding). |
| | | | Set to 0 otherwise. |
| B12-B13 | Reserved | 2 | Reserved and each bit is set to 1. |
| B14-B17 | CRC | 4 | |
| B18-B23 | Tail Bits | 6 | |

### Example 1

This example is the simplest with the fewest feature supports. The reserved entry in Midamble Periodicity may be used, i.e., the fourth entry with value 3, to indicate the NDP frame. For example, if B8-B9 is set to 3, NDP is indicated. The format of NGV-LTF in the ranging NDP can be only one type and can be mandated by the 802.11 spec, e.g., NGV-LTF-2x-Repeat (or NGV-LTF-2x). The indication of the NGV-LTF type is the same as the data PPDU. For example, MCS may be set to n=10 for DCM for using NGV-LTF-2x-Repeat, and MCS may be set to other values and LTF Format may be set to 0 for using NGV-LTF-2x. The NDPA frame of 11az can be reused for 11bd.

If support NGV-LTF field repetition is wanted, the repetition number may be indicated for example using the following bits: B11 LDPC Extra OFDM Symbol and/or B12-B13 Reserved bits and/or B3-B6 MCS. For example, B11 is set to 1 for NGV-LTF field repetition (e.g. two NGV-LTF fields) and B11 is set to 0 otherwise.

### Example 2

This example is similar to the previous except the multiple types of NGV-LTF can be used. The reserved entry in Midamble Periodicity may be used, i.e., the fourth entry with value 3, to indicate the NDP frame. For example, if B8-B9 is set 3, NDP is indicated. The format of NGV-LTF in the ranging NDP can be selected from the existing types, e.g., NGV-LTF-2x-Repeat and NGV-LTF-2x. The indication of the NGV-LTF type is the same as the 11bd data PPDU. For example, MCS may be set to n=10 for DCM for using NGV-LTF-2x-Repeat, and MCS may be set to other values and LTF Format may be set to 0 for using NGV-LTF-2x.

### Example 3

The reserved entries in MCS field may be used, i.e., 11-15, to indicate the NDP frame. For example, for B3-B6, set n=11 to indicate NDP. The format of NGV-LTF in the NDP can be indicated by B10, LTF Format field. Since NGV-LTF-1x may not be desirable for ranging due to the weak signal energy, NGV-LTF-2x-repeat may be used instead. For example, set B10 to 0 for NGV-LTF-2x; and set B10 to 1 for NGV-LTF-2x-Repeat; or vice versa. If NGV-LTF-2x-Repeat is not used for ranging, then B10 can be used as before, i.e., 0 for NGV-LTF-2x and 1 for NGV-LTF-1x. The irrelevant fields like B8-B9 and B11 can be reserved. The useful fields like B1-B2, B3, and B7 can be reused the same way as in the data PPDU.

### Example 4

The reserved entries in MCS field may be used to indicate the NDP frame. For example, for B3-B6, set n=11 to indicate NDP. The format of NGV-LTF in the NDP can be indicated by B10 and B11. For example, B10-B11 can be set as: 00 for NGV-LTF-2x, 10 for NGV-LTF-1x, 01 for NGV-2x-Repeat, (and may be 11 for two copies of NGV-LTF-2x-Repeat). The irrelevant fields like B8-B9 can be reserved. The useful fields like B1-B2, B3, and B7 can be reused the same way as in the data PPDU.

### Example 5

The reserved entries in MCS field may be used to indicate the NDP frame. For example, for B3-B6, set n=11 to indicate NDP. The format of NGV-LTF in the NDP can be indicated by B8-B9, Midamble Periodicity field. For example, set B8-B9 to 0 for NGV-LTF-1x; set B8-B9 to 1 for NGV-LTF-2x; set B8-B9 to 2 for NGV-LTF-2x-Repeat; set B8-B9 to 3 for two copies of NGV-LTF-2x-Repeat (or NGV-LTF-2x-Repeat with NGV-LTF field repetition). The irrelevant fields like B10 and B11 can be reserved. The useful fields like B1-B2, B3, and B7 can be reused the same way as in the data PPDU.

### Example 6

The reserved entries in MCS field may be used to indicate the NDP frame and the NGV-LTF format. For example, for B3-B6, set n=11 to indicate NDP with NGV-LTF-1x; set n=12 to indicate NDP with NGV-LTF-2x; and set n=13 to indicate NDP with NGV-LTF-2x-Repeat; set n=14 to indicate NDP with two copies of NGV-LTF-2x-Repeat (or NGV-LTF-2x-Repeat with NGV-LTF field repetition). If NGV-LTF-1x and NGV-LTF field repetition are not supported, two entries may be used, e.g., n=11 for NDP with NGV-LTF-2x and n=12 for NDP with NGV-LTF-2x-Repeat. The irrelevant fields like B10 and B11 can be reserved (or ignored). The useful fields like B1-B2, B3, and B7 can be reused the same way as in the data PPDU.

The examples above talk little about the indication for the repetition of NGV-LTF field as illustrated in FIGS. 8 (b) and (c). The indication of the repetition can be jointly with the indication of NGV-LTF format or can be separate using additional reserved entries or field.

### Example 7

The reserved entries in MCS field may be used to indicate the NDP frame. For example, for B3-B6, set n=11 to indicate NDP. The format of NGV-LTF in the NDP can be indicated by B10, LTF Format field. B8-B9, Midamble Periodicity, can be used to indicate the number of repetitions, e.g., setting n to 0: 1 NGV-LTF; 1: 2 NGV-LTFs; 2: 3 NGV-LTFs; and 3: 4 NGV-LTFs.

In the examples above, it is desirable that the settings of NGV-LTF format (e.g., 1x, 2x, and 2x-Repeat) and NGV-LTF field repetition remain the same for both the I2R NDP and the R2I NDP. The 802.11bd spec can mandate this.

For calculating the length field of L-SIG and RL-SIG, the parameter of TXTIME in 802.11bd spec needs to take into account the removal of data symbols and the addition of extra NGV-LTF symbols and maybe the PE.

NDP Announcement Frame

The NDPA frame of 11az may be reused, whose STA Info field is shown in FIG. 10, for 11bd with some modifications.

Same as 1az, the 11bd ranging NDPA may be indicated by setting the HE subfield and the Ranging subfield in the Sounding Dialog Token field. The Ranging NDPA frame contains at least one STA Info field. If the Ranging NDPA frame contains only one STA Info field, then the RA address is set to the address of the RSTA (or ISTA) that is the intended recipient of the frame. If the Ranging NDPA frame contains more than one STA Info field, then the RA field is set to the broadcast address. For the non-trigger-based (non-TB) ranging of 11bd in FIG. 6, the AID11 field in FIG. 10 can be set to 0 the same as 11az.

Since 11bd only supports single user (SU) mode, the LTF Offset field is not used or can be set to zero. The setting of the remaining fields in FIG. 10 can be the same as 11az. If adding the support of multiple NGV-LTF formats is desired, then there are two ways. One way is to use the reserved bits, i.e., B26 and B31, to indicate the NGV-LTF format directly. The other way is to use one of the two reserved bits to indicate the STA Info field is for 11bd instead of 11az and then reuse the bits in the unused field(s), e.g., LTF Offset field and AID11, to indicate the NGV-LTF format. The indication using the reserved bit differentiates the 11bd STA Info field from the 11az STA Info field so that the other bits in the STA Info field can be redefined and reused.

For simplicity, 11bd may not support multiple NGV-LTF formats. In this case, the NDA frame of 11az can be reused. The AID11 and LTF Offset may be set to 0 for 11bd. R2I Rep and I2R Rep can be reused by 11bd if 11bd supports NGV-LTF field repetition as illustrated in FIGS. 8 (b) and (c).

For other control frames and management frames such as initial Fine Timing Measurement Request frame (IFTMR), initial Fine Timing Measurement frame (IFTM), and location measurement report (LMR), 11bd may reuse the ones of 11az. It is understood that the above descriptions are for purposes of illustration and are not meant to be limiting.

In some embodiments, when used as part of non-TB Ranging measurement exchange for Non-TB Ranging measurement exchange, the I2R N_STS and I2R Rep subfields are used to indicate the configuration of HE-LTF and NGV-LTF of the following I2R NDPs. The R2I N_STS and R2I Rep subfields indicate the configuration of HE-LTF and NGV-LTF of the R2I NDP sent in response by the RSTA. When a Ranging NDP Announcement frame is configured for NGV ranging, the subfields of the STA Info field shall be set as follows:
LTF Offset shall be set to zero.
R2I N_STS shall be set to the number of spatial streams of the R2I NDP.
R2I Rep shall be set to 0 if the NGV-LTF in the R2I NDP is not repeated and shall be set to 1 if the
NGV-LTF in the R2I NDP is repeated.
I2R N_STS shall be set to the number of spatial streams of the I2R NDP.
I2R Rep shall be set to 0 if the NGV-LTF in the R2I NDP is not repeated and shall be set to 1 if the
NGV-LTF in the R2I NDP is repeated.

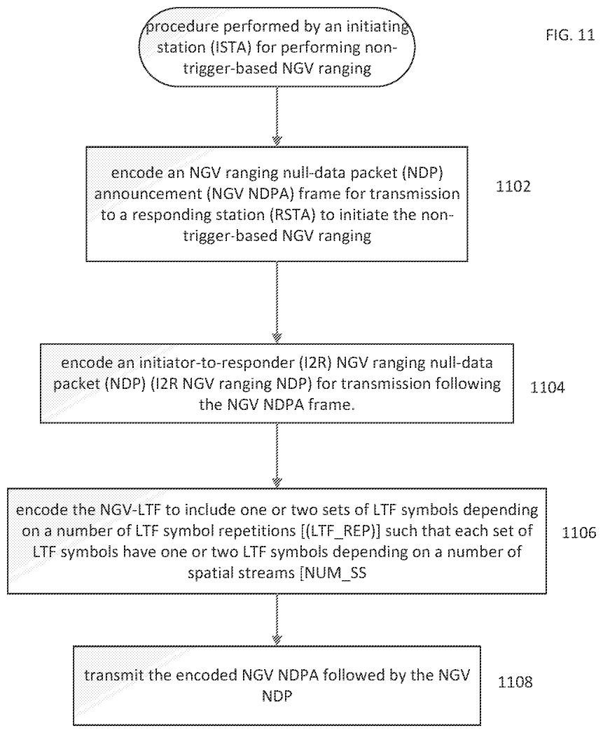

FIG. 11 is a flow chart illustrating a procedure performed by an initiating station (ISTA) for performing non-trigger-based NGV ranging. In operation 1102, the NGV STA is configured to encode an NGV ranging null-data packet (NDP) announcement (NGV NDPA) frame for transmission to a responding station (RSTA) to initiate the non-trigger-based NGV ranging.

In operation 1104, the NGV STA is configured to encode an initiator-to-responder (I2R) NGV ranging null-data packet (NDP) (I2R NGV ranging NDP) for transmission following the NGV NDPA frame. The I2R NGV ranging NDP may be encoded in accordance with a NGV Ranging NDP format, the NGV ranging NDP encoded to include an NGV signal field (NGV-SIG), a repeated NGV-SIG (RNGV-SIG), an NGV Short Training field (NGV-STF) and an NGV long training field (NGV-LTF).

In operation 1106, the NGV STA is encodes the NGV-LTF to include one or two sets of LTF symbols depending on a number of LTF symbol repetitions [(LTF_REP)] such that each set of LTF symbols have one or two LTF symbols depending on a number of spatial streams [NUM_SS]. In operation 1108, the NGV STA may transmit the encoded NGV NDPA followed by the NGV NDP.

### EXAMPLES

Example 1 may include a device comprising processing circuitry coupled to storage, the processing circuitry configured to: determine a frame comprising one or more fields, the one or more fields comprising a next generation vehicle (NGV) long training field (LTF) field; cause to send the frame to a first station device of one or more station devices to perform ranging.
Example 2 may include the device of example 1 and/or some other example herein, wherein the NGV-LTF field may be repeated.
Example 3 may include the device of example 1 and/or some other example herein, wherein at least one of the one or more fields may be a packet extension (PE) field, wherein the PE may be appended to the NGV-LTF for providing the first station device additional processing time.
Example 4 may include the device of example 1 and/or some other example herein, further comprising a transceiver configured to transmit and receive wireless signals.
Example 5 may include the device of example 4 and/or some other example herein, further comprising an antenna coupled to the transceiver to cause to send the frame.
Example 6 may include a non-transitory computer-readable medium storing computer-executable instructions which when executed by one or more processors result in performing operations comprising: determining a frame comprising one or more fields, the one or more fields comprising an next generation vehicle (NGV) long training field (LTF) field; causing to send the frame to a first station device of one or more station devices to perform ranging.
Example 7 may include the non-transitory computer-readable medium of example 6 and/or some other example herein, wherein the NGV-LTF field may be repeated.
Example 8 may include the non-transitory computer-readable medium of example 6 and/or some other example herein, wherein at least one of the one or more fields may be a packet extension (PE) field, wherein the PE may be appended to the NGV-LTF for providing the first station device additional processing time.
Example 9 may include a method comprising: determining, by one or more processors, a frame comprising one or more fields, the one or more fields comprising an next generation vehicle (NGV) long training field (LTF) field; causing to send the frame to a first station device of one or more station devices to perform ranging.
Example 10 may include the method of example 9 and/or some other example herein, wherein the NGV-LTF field may be repeated.
Example 11 may include the method of example 9 and/or some other example herein, wherein at least one of the one or more fields may be a packet extension (PE) field, wherein the PE may be appended to the NGV-LTF for providing the first station device additional processing time.
Example 12 may include an apparatus comprising means for: determining a frame comprising one or more fields, the one or more fields comprising a next generation vehicle (NGV) long training field (LTF) field; causing to send the frame to a first station device of one or more station devices to perform ranging.
Example 13 may include the apparatus of example 12 and/or some other example herein, wherein the NGV-LTF field may be repeated.
Example 14 may include the apparatus of example 12 and/or some other example herein, wherein at least one of the one or more fields may be a packet extension (PE) field, wherein the PE may be appended to the NGV-LTF for providing the first station device additional processing time.
Example 15 may include one or more non-transitory computer-readable media comprising instructions to cause an electronic device, upon execution of the instructions by one or more processors of the electronic device, to perform one or more elements of a method described in or related to any of examples 1-14, or any other method or process described herein.
Example 16 may include an apparatus comprising logic, modules, and/or circuitry to perform one or more elements of a method described in or related to any of examples 1-14, or any other method or process described herein.
Example 17 may include a method, technique, or process as described in or related to any of examples 1-14, or portions or parts thereof.
Example 18 may include an apparatus comprising: one or more processors and one or more computer readable media comprising instructions that, when executed by the one or more processors, cause the one or more processors to perform the method, techniques, or process as described in or related to any of examples 1-14, or portions thereof.
Example 19 may include a method of communicating in a wireless network as shown and described herein.
Example 20 may include a system for providing wireless communication as shown and described herein.
Example 21 may include a device for providing wireless communication as shown and described herein.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus of a next generation vehicle-to-everything (NGV) station (STA), the apparatus comprising: processing circuitry; and memory,
wherein when operating as an initiating station (ISTA) for performing non-trigger-based NGV ranging, the processing circuitry is configured to:
encode an NGV ranging null-data packet (NDP) announcement (NGV NDPA) frame for transmission to a responding station (RSTA) to initiate the non-trigger-based NGV ranging; and
encode an initiator-to-responder (I2R) NGV ranging null-data packet (NDP) (I2R NGV ranging NDP) for transmission following the NGV NDPA frame,
the I2R NGV ranging NDP encoded in accordance with a NGV Ranging NDP format, the NGV ranging NDP encoded to include an NGV signal field (NGV-SIG), a repeated NGV-SIG (RNGV-SIG), an NGV Short Training field (NGV-STF) and an NGV long training field (NGV-LTF),
wherein the NGV-LTF is configurable to include one or two sets of LTF symbols depending on a number of LTF symbol repetitions,
wherein each set of LTF symbols have one or two LTF symbols depending on a number of spatial streams,
wherein the processing circuitry is configured to set a predetermined bit in the NGV-SIG to a predetermined value to indicate that that the NGV Ranging NDP is an NGV Ranging NDP with NGV-LTF repetition, and
wherein the memory is configured to store the number of spatial streams.

2. The apparatus of claim 1, wherein the NGV-LTF is encoded in symbol format NGV-LTF-2x,
wherein symbols of the NGV-LTF have a duration of 8 microseconds (μs), and
wherein the NGV-LTF it transmitted with a cyclic prefix (CP) of 1.6 μs.

3. The apparatus of claim 2, wherein the NGV-SIG, the RNGV-SIG, the NGV-STF and the NGV-LTF, each have a symbol duration of 8 μs.

4. The apparatus of claim 3, wherein for two spatial streams with LTF symbol repetition equaling one (LTF_REP=1), the processing circuitry is configured to encode the NFV-LTF to include a first repetition comprising two NGV-LTF-2x symbols and a second repetition comprising two LTF-2x symbols.

5. The apparatus of claim 4, wherein for transmission of an NGV PPDU with a data field and for transmission of an NGV Ranging NDP without NGV-LTF repetition, the processing circuitry is configured to set the predetermined bit in the NGV-SIG to another predetermined value.

6. The apparatus of claim 5, wherein the NGV-SIG is encoded to include a bit to indicate whether the I2R NGV ranging NDP has a transmission bandwidth of 10 MHz or 20 MHz.

7. The apparatus of claim 6, wherein in response to transmission of the I2R NGV ranging NDP, the processing circuitry is configured to decode a responder-to-initiator NGV-NDP (R2I NGV NDP) from the RSTA following by an R2I link management report (R2I LMR) frame, the R2I LMR frame reporting an arrival time of the I2R NGV NDP and a departure time of the R2I NGV NDP.

8. The apparatus of claim 7, wherein the NGV STA is configured for multiple frame transmission in an EDCA TXOP,
wherein during the EDCA TXOP, the processing circuitry is to configure the NGV STA to:
transmit the NGV Ranging NDP Announcement frame;
transmit the I2R NGV ranging NDP an SIFS after the NGV Ranging NDP Announcement frame;
receive the R2I NGV ranging NDP an SIFS after the I2R NGV ranging NDP;
receive the R2I LMR frame an SIFS after the R2I NGV ranging NDP; and
optionally transmit a I2R LMR frame an SIFS after receipt of the R2I LMR frame.

9. The apparatus of claim 8 wherein the processing circuitry is configured to encode the NGV NDPA frame to include a STA information field, wherein for NGV ranging, the processing circuitry is configured to set one or more subfields of the STA information as follows:
an LTF Offset subfield is set to zero;
an R2I N_STS subfield is set to the number of spatial streams of the R2I NGV ranging NDP or the number of spatial streams of the R2I NGV ranging NDP minus 1;
an R2I Rep subfield is set to 0 if the NGV-LTF in the R2I NGV ranging NDP is not repeated and is set to 1 if the NGV-LTF in the R2I NGV ranging NDP is repeated;
an I2R N_STS subfield is set to a number of spatial streams of the I2R NGV ranging NDP or a number of spatial streams of the I2R NGV ranging NDP minus 1; and
an I2R Rep subfield is set to 0 if the NGV-LTF in the R2I NGV ranging NDP is not repeated and is set to 1 if the NGV-LTF in the R2I NGV ranging NDP is repeated.

10. The apparatus of claim 1, wherein the processing circuitry comprises a baseband processor.

11. A non-transitory computer-readable storage medium that stores instructions for execution by processing circuitry of a next generation vehicle-to-everything (NGV) station (STA), wherein when operating as an initiating station (ISTA) for performing non-trigger-based NGV ranging, the processing circuitry is configured to:
encode an NGV ranging null-data packet (NDP) announcement (NGV NDPA) frame for transmission to a responding station (RSTA) to initiate the non-trigger-based NGV ranging; and
encode an initiator-to-responder (I2R) NGV ranging null-data packet (NDP) (I2R NGV ranging NDP) for transmission following the NGV NDPA frame,
the I2R NGV ranging NDP encoded in accordance with a NGV Ranging NDP format, the NGV ranging NDP encoded to include an NGV signal field (NGV-SIG), a repeated NGV-SIG (RNGV-SIG), an NGV Short Training field (NGV-STF) and an NGV long training field (NGV-LTF),
wherein the NGV-LTF is configurable to include one or two sets of LTF symbols depending on a number of LTF symbol repetitions,
wherein each set of LTF symbols have one or two LTF symbols depending on a number of spatial streams, and
wherein the processing circuitry is configured to set a predetermined bit in the NGV-SIG to a predetermined value to indicate that that the NGV Ranging NDP is an NGV Ranging NDP with NGV-LTF repetition.

12. The non-transitory computer-readable storage medium of claim 11, wherein the NGV-LTF is encoded in symbol format NGV-LTF-2x,
wherein symbols of the NGV-LTF have a duration of 8 microseconds (μs), and
wherein the NGV-LTF it transmitted with a cyclic prefix (CP) of 1.6 μs.

13. The non-transitory computer-readable storage medium of claim 12,
wherein the NGV-SIG, the RNGV-SIG, the NGV-STF and the NGV-LTF, each have a symbol duration of 8 μs.

14. The non-transitory computer-readable storage medium of claim 13, wherein for two spatial streams with LTF symbol repetition equaling one (LTF_REP=1), the processing circuitry is configured to encode the NFV-LTF to include a first repetition comprising two NGV-LTF-2x symbols and a second repetition comprising two LTF-2x symbols.

15. The non-transitory computer-readable storage medium of claim 14, wherein for transmission of an NGV PPDU with a data field and for transmission of an NGV Ranging NDP without NGV-LTF repetition, the processing circuitry is configured to set the predetermined bit in the NGV-SIG to another predetermined value.

16. The non-transitory computer-readable storage medium of claim 15, wherein the NGV-SIG is encoded to include a bit to indicate whether the I2R NGV ranging NDP has a transmission bandwidth of 10 MHz or 20 MHz.

17. The non-transitory computer-readable storage medium of claim 16, wherein in response to transmission of the I2R NGV ranging NDP, the processing circuitry is configured to decode a responder-to-initiator NGV-NDP (R2I NGV NDP) from the RSTA following by an R2I link management report (R2I LMR) frame, the R2I LMR frame reporting an arrival time of the I2R NGV NDP and a departure time of the R2I NGV NDP.

18. The non-transitory computer-readable storage medium of claim 17, wherein the NGV STA is configured for multiple frame transmission in an EDCA TXOP.

19. An apparatus of a next generation vehicle-to-everything (NGV) station (STA), the apparatus comprising: processing circuitry; and memory, wherein when operating as a responding station (RSTA) for performing non-trigger-based NGV ranging, the processing circuitry is configured to:
decode an NGV ranging null-data packet (NDP) announcement (NGV NDPA) frame received from an initiating station (ISTA), the NGV NDPA to initiate the non-trigger-based NGV ranging; and
decode an initiator-to-responder (I2R) NGV ranging null-data packet (NDP) (I2R NGV ranging NDP) received from the ISTA following the NGV NDPA frame, the I2R NGV ranging NDP encoded in accordance with a NGV Ranging NDP format, the NGV ranging NDP encoded to include an NGV signal field (NGV-SIG), a repeated NGV-SIG (RNGV-SIG), an NGV Short Training field (NGV-STF) and an NGV long training field (NGV-LTF),
wherein the NGV-LTF includes one or two sets of LTF symbols depending on a number of LTF symbol repetitions,
wherein each set of LTF symbols have one or two LTF symbols depending on a number of spatial streams,
wherein the processing circuitry is configured to set a predetermined bit in the NGV-SIG to a predetermined value to indicate that that the NGV Ranging NDP is an NGV Ranging NDP with NGV-LTF repetition, and
wherein the memory is configured to store the number of spatial streams.

20. The apparatus of claim 19, wherein the NGV-LTF is decoded in accordance with symbol format NGV-LTF-2x, and wherein symbols of the NGV-LTF have a duration of 8 microseconds (μs) with a cyclic prefix (CP) of 1.6 μs, and
wherein the NGV-SIG, the RNGV-SIG, the NGV-STF and the NGV-LTF, each have a symbol duration of 8 μs.
